(19) United States
(12) Patent Application Publication
(10) Pub. No.: US 2022/0220277 A1
(43) Pub. Date: Jul. 14, 2022

(54) EPDM ROOFING MEMBRANES MADE BY PROCESSES EMPLOYING A EUTECTIC MIXTURE

(71) Applicant: Firestone Building Products Company, LLC, Nashville, TN (US)

(72) Inventor: Hao WANG, Carmel, IN (US)

(21) Appl. No.: 17/607,191

(22) PCT Filed: Apr. 16, 2020
(86) PCT No.: PCT/US2020/028456

§ 371 Date: Oct. 28, 2021

Related U.S. Application Data
(60) Provisional application No. 62/840,500, filed on Apr. 30, 2019.

(51) Int. Cl. C08K 3/22; C08K 9/12; C08K 5/21; C08K 5/19; C08K 5/09; C08K 5/05; E04D 5/08

(52) U.S. Cl. CPC C08K 3/22; C08K 9/12; C08K 5/21; C08K 2003/2296; C08K 5/09; C08K 5/05; E04D 5/08; C08K 5/19

(57) ABSTRACT

A method of preparing an EPDM roofing membrane panel includes preparing a vulcanizable composition including a eutectic composition by mixing an EPDM rubber, a sulfur-based curative, zinc oxide, and a eutectic composition; forming a sheet from the vulcanizable composition; preparing a green membrane panel using the sheet; and curing the green membrane panel to form the EPDM roofing membrane panel.

### FIELD OF THE INVENTION

Embodiments of the present invention are directed toward EPDM roofing membranes made by processes that include sulfur curing a vulcanizable rubber composition including a eutectic composition.

### BACKGROUND OF THE INVENTION

Ethylene-propylene-diene terpolymer (EPDM) is extensively used in a variety of applications. For example, it is particularly useful as a polymeric sheeting material that, because of its physical properties, which include flexibility, weathering resistance, low-temperature properties and heat-aging resistance, has gained acceptance as a roofing membrane for covering industrial and commercial roofs. These rubber roofing membranes are typically applied to the roof surface in a vulcanized or cured state and serve as an effective roof covering to protect the underlying structure from the environment.

EPDM roofing membranes, which may also be referred to as singly-ply membranes or roof coverings, are typically prepared by compounding EPDM polymer with appropriate fillers, processing oils, and other desired ingredients such as plasticizers, antidegradants, adhesive-enhancing promoters, etc., in a suitable mixer, and calendering the resulting compound into the desired thickness to form an uncured sheet. The uncured sheet is then cured by vulcanizing the EPDM in the presence of one or more vulcanizing agents and/or compatible vulcanizing accelerators.

Where the EPDM is sulfur vulcanized, zinc oxide is typically employed as an essential ingredient, typically in combination with stearic acid. It is believed that zinc species and/or zinc oxide serve as an activator for the sulfur crosslinking. It is also believed that the zinc oxide and stearic acid form, in situ, zinc species, and in combination with the zinc oxide, the rate and quality of the sulfur vulcanization process is impacted.

### SUMMARY OF THE INVENTION

One or more embodiments of the present invention provide a method of preparing an EPDM rubber roofing membrane panel comprising preparing a vulcanizable composition including a eutectic composition by mixing an EPDM rubber, a sulfur-based curative, zinc oxide, and a eutectic composition, forming a sheet from the vulcanizable composition, preparing a green membrane panel using the sheet, and curing the green membrane panel to form the EPDM rubber roofing membrane panel.

Other embodiments of the present invention provide a process for preparing an EPDM roofing membrane rubber vulcanizate, the process comprising providing a vulcanizable composition of matter including vulcanizable EPDM rubber, a sulfur-based curative, zinc oxide, and a eutectic composition; and heating the vulcanizable composition to thereby effect vulcanization.

Yet other embodiments of the present invention provide an EPDM rubber roofing membrane comprising at least one layer of a cured rubber made by a process employing a eutectic composition.

Still other embodiments of the present invention provide an EPDM rubber roofing membrane vulcanizate comprising a vulcanized rubber network including a metal compound dispersed throughout the rubber network, the rubber network including less than 2 parts by weight zinc oxide per 100 parts by weight rubber.

Yet other embodiments of the present invention provide a method for preparing a vulcanizable composition of matter, the method comprising combining a vulcanizable EPDM rubber, a curative, and a eutectic composition.

### BRIEF DESCRIPTION OF THE DRAWINGS

FIG. 1 is a perspective, cross-sectional view of an EPDM membrane according to embodiments of the invention.

FIG. 2 is a flow chart describing a process for making an EPDM membrane according to embodiments of the invention.

### DETAILED DESCRIPTION OF ILLUSTRATIVE EMBODIMENTS

Embodiments of the present invention are based, at least in part, upon the discovery of a method of preparing an EPDM rubber roofing membrane panel. In one or more embodiments, the method may include preparing a vulcanizable composition including EPDM rubber, a sulfur-based curative, zinc oxide, and a eutectic composition, forming a sheet from the vulcanizable composition, preparing a green membrane panel using the sheet, and curing the green membrane panel to form the EPDM rubber roofing membrane panel. Advantageously, by including the eutectic composition in the vulcanizable composition, it is contemplated that the total loading of metal compounds (e.g. zinc oxide) that are necessary to achieve a desired cure can be appreciably reduced without a deleterious impact on cure rate and/or cure quality of the EPDM rubber. Accordingly, embodiments of the invention provide cured EPDM rubber roofing membranes having relatively low levels of metal, such as zinc, and technologically useful level of cure.

### Vulcanizable Compositions

As indicated above, in one or more embodiments of the invention, a eutectic composition is included in a vulcanizable composition for the production of a cured EPDM rubber roofing membrane panel. In addition to the eutectic composition, the vulcanizable compositions of one or more embodiments include a vulcanizable EPDM rubber, a filler, a curative (e.g. sulfur-based curative), an organic acid, such as stearic acid, and a metal compound, such as zinc oxide or derivatives of zinc oxide. Other optional ingredients may also be included such as, but not limited to, processing and/or extender oils, resins, waxes, cure accelerators, scorch inhibitors, antidegradants, antioxidants, plasticizers, and other rubber compounding additives known in the art.

### Eutectic Mixture

In one or more embodiments, a eutectic composition includes those compositions formed by combining two or more compounds that provide a resultant combination having a melting point lower than the respective compounds that are combined. For purposes of this specification, eutectic composition may be referred to as a eutectic mixture, eutectic complex, or eutectic pair. Each of the compounds that are combined may be referred to, respectively, as a eutectic ingredient, eutectic constituent, eutectic member, or compound for forming a eutectic composition (e.g. first and second compound). Depending on the relative amounts of the respective eutectic ingredients, as well as the temperature at which the observation is made, the eutectic composition may be in the form of a liquid, which may be referred to as a eutectic liquid or eutectic solvent. For a given composition, where relative amounts of the respective ingredients are at or proximate to the lowest melting point of the eutectic mixture, then composition may be referred to as a deep eutectic solvent, which may be referred to as DES.

Without wishing to be bound by any particular theory, it is believed that the eutectic ingredients combine or otherwise react or interact to form a complex. Thus, any reference to eutectic mixture, or eutectic combination, eutectic pair, or eutectic complex will include combinations and reaction products or complexes between the constituents that are combined and yield a composition having a lower melting point than the respective constituents. For example, in one or more embodiments, useful eutectic compositions can be defined by the formula I:

Cat+X⁻zY

where Cat⁺ is a cation, X⁻ is a counter anion (e.g. Lewis Base), and z refers to the number of Y molecules that interact with the counter anion (e.g. Lewis Base). For example, Cat⁺ can include an ammonium, phosphonium, or sulfonium cation. X⁻ may include, for example, a halide ion. In one or more embodiments, z is a number that achieves a deep eutectic solvent, or in other embodiments, a number that otherwise achieves a complex having a melting point lower than the respective eutectic constituents.

In one or more embodiments, a useful eutectic composition includes a combination of an acid and a base, where the acid and base may include Lewis acids and bases or Bronsted acids and bases. In one or more embodiments, useful eutectic compositions include a combination of a quaternary ammonium salt with a metal halide (which are referred to as Type I eutectic composition), a combination of a quaternary ammonium salt and a metal halide hydrate (which are referred to as Type II eutectic composition), a combination of a quaternary ammonium salt and a hydrogen bond donor (which are referred to as Type III eutectic composition), or a combination of a metal halide hydrate and a hydrogen bond donor (which are referred to as Type IV eutectic composition).

Analogous combinations of sulfonium or phosphonium in lieu of ammonium compounds can also be employed and can be readily envisaged by those having skill in the art.

### Quaternary Ammonium Salt

In one or more embodiments, the quaternary ammonium salt is a solid at 20° C. In these or other embodiments, the metal halide and hydrogen bond donor are solid at 20° C.

In one or more embodiments, useful quaternary ammonium salts, which may also be referred to as ammonium compounds, may be defined by the formula II:

(R₁)(R₂)(R₃)(R₄)—N⁺-Φ⁻

where each R₁, R₂, R₃, and R₄ is individually hydrogen or a monovalent organic group, or, in the alternative, two of R₁, R₂, R₃, and R₄ join to form a divalent organic group, and Φ⁻ is a counter anion. In one or more embodiments, at least one, in other embodiments at least two, and in other embodiments at least three of R₁, R₂, R₃, and R₄ are not hydrogen.

In one or more embodiments, the counter anion (e.g. Φ⁻) is selected from the group consisting of halide (X⁻), nitrate (NO₃⁻), tetrafluoroborate (BF₄⁻), perchlorate (ClO₄⁻), triflate (SO₃CF₃⁻), trifluoroacetate (COOCF₃⁻). In one or more embodiments, Φ⁻ is a halide ion, and in certain embodiments a chloride ion.

In one or more embodiments, the monovalent organic groups include hydrocarbyl groups, and the divalent organic groups include hydrocarbylene groups. In one or more embodiments, the monovalent and divalent organic groups include a heteroatom, such as, but not limited to, oxygen and nitrogen, and/or a halogen atom. Accordingly, the monovalent organic groups may include alkoxy groups, siloxy groups, ether groups, and ester groups, as well as carbonyl or acetyl substituents. In one or more embodiments, the hydrocarbyl groups and hydrocarbylene group include from 1 (or the appropriate minimum number) to about 18 carbon atoms, in other embodiments from 1 to about 12 carbon atoms, and in other embodiments from 1 to about 6 carbon atoms. The hydrocarbyl and hydrocarbylene groups may be branched, cyclic, or linear. Exemplary types of hydrocarbyl groups include alkyl, cycloalkyl, aryl and alkylaryl groups. Exemplary types of hydrocarbylene groups include alkylene, cycloalkylene, arylene, and alkylarylene groups. In particular embodiments, the hydrocarbyl groups are selected from the group consisting of methyl, ethyl, octadecyl, phenyl, and benzyl groups. In certain embodiments, the hydrocarbyl groups are methyl groups, and the hydrocarbylene groups are ethylene or propylene group.

Useful types of ammonium compounds include secondary ammonium compounds, tertiary ammonium compounds, and quaternary ammonium compounds. In these or other embodiments, the ammonium compounds include ammonium halides such as, but not limited to, ammonium chloride. In particular embodiments, the ammonium compound is a quaternary ammonium chloride. In certain embodiments, R₁, R₂, and R₃ R₄ are hydrogen, and the ammonium compound is ammonium chloride. In one or more embodiments, the ammonium compounds are asymmetric.

In one or more embodiments, the ammonium compound includes an alkoxy group and can be defined by the formula III:

(R₁)(R₂)(R₃)—N⁺—(R₄—OH)Φ⁻

where each R₁, R₂, and R₃ is individually hydrogen or a monovalent organic group, or, in the alternative, two of R₁, R₂, and R₃ join to form a divalent organic group, R₄ is a divalent organic group, and Φ⁻ is a counter anion. In one or more embodiments, at least one, in other embodiments at least two, and in other embodiments at least three of R₁, R₂, R₃, and are not hydrogen.

Examples of ammonium compounds defined by the formula III include, but are not limited to, N-ethyl-2-hydroxy-N,N-dimethylethanaminium chloride, 2-hydroxy-N,N,N-trimethylethanaminium chloride (which is also known as choline chloride), and N-benzyl-2-hydroxy-N,N-dimethlethanaminium chloride.

In one or more embodiments, the ammonium compound includes a halogen-containing substituent and can be defined by the formula IV:

Φ⁻-(R₁)(R₂)(R₃)—N⁺—R₄X

where each R₁, R₂, and R₃ is individually hydrogen or a monovalent organic group, or, in the alternative, two of R₁, R₂, and R₃ join to form a divalent organic group, R₄ is a divalent organic group, X is a halogen atom, and Φ⁻ is a counter anion. In one or more embodiments, at least one, in other embodiments at least two, and in other embodiments at least three of R₁, R₂, and R₃ are not hydrogen. In one or more embodiments, X is chlorine.

Examples of ammonium compounds defined by the formula III include, but are not limited to, 2-chloro-N,N,N-trimethylethanaminium (which is also referred to as chlorcholine chloride), and 2-(chlorocarbonyloxy)-N,N,N-trimethylethanaminium chloride.

### Hydrogen-Bond Donor Compounds

In one or more embodiments, the hydrogen-bond donor compounds, which may also be referred to as HBD compounds, include, but are not limited to, amines, amides, carboxylic acids, and alcohols. In one or more embodiments, the hydrogen-bond donor compound includes a hydrocarbon chain constituent. The hydrocarbon chain constituent may include a carbon chain length including at least 2, in other embodiments at least 3, and in other embodiments at least 5 carbon atoms. In these or other embodiments, the hydrocarbon chain constituent has a carbon chain length of less than 30, in other embodiments less than 20, and in other embodiments less than 10 carbon atoms.

In one or more embodiments, useful amines include those compounds defined by the formula:

R₁—(CH₂)ₓ—R₂

wherein R₁ and R₂ are —NH₂, —NHR₃, or —NR₃R₄, and x is an integer of at least 2. In one or more embodiments, x is from 2 to about 10, in other embodiments from about 2 to about 8, and in other embodiments from about 2 to about 6.

Specific examples of useful amines include, but are not limited to, aliphatic amines, ethylenediamine, diethylenetriamine, aminoethylpiperazine, triethylenetetramine, tris(2-amino ethyl) amine, N,N′-bis-(2aminoethyle)piperazine, piperazinoethylethylenediamine, and tetraethylenepentaamine, propyleneamine, aniline, substituted aniline, and combinations thereof.

In one or more embodiments, useful amides include those compounds defined by the formula:

R—CO—NH₂

wherein R is H, NH₂, CH₃, or CF₃.

Specific examples of useful amides include, but are not limited to, urea, 1-methyl urea, 1,1-dimethyl urea, 1,3-dimethylurea, thiourea, urea, benzamide, acetamide, and combinations thereof.

In one or more embodiments, useful carboxylic acids include mono-functional, di-functional, and tri-functional organic acids. These organic acids may include alkyl acids, aryl acids, and mixed alkyl-aryl acids.

Specific examples of useful mono-functional carboxylic acids include, but are not limited to, aliphatic acids, phenylpropionic acid, phenylacetic acid, benzoic acid, and combinations thereof. Specific examples of di-functional carboxylic acids include, but are not limited to, oxalic acid, malonic acid, adipic acid, succinic acid, and combinations thereof. Specific examples of tri-functional carboxylic acids include citric acid, tricarballylic acid, and combinations thereof.

Types of alcohols include, but are not limited to, monools, diols, and triols. Specific examples of monools include aliphatic alcohols, phenol, substituted phenol, and mixtures thereof. Specific examples of diols include ethylene glycol, propylene glycol, resorcinol, substituted resorcinol, and mixtures thereof. Specific examples of triols include, but are not limited to, glycerol, benzene triol, and mixtures thereof.

### Metal Halides

Types of metal halides include, but are not limited to, chlorides, bromides, iodides and fluorides. In one or more embodiments, these metal halides include, but are not limited to, transition metal halides. The skilled person can readily envisage the corresponding metal halide hydrates.

Specific examples of useful metal halides include, but are not limited to, aluminum chloride, aluminum bromide, aluminum iodide, zinc chloride, zinc bromide, zinc iodide, tin chloride, tin bromide, tin iodide, iron chloride, iron bromide, iron iodide, and combinations thereof. The skilled person can readily envisage the corresponding metal halide hydrates. For example, aluminum chloride hexahydrate and copper chloride dihydrate correspond to the halides mentioned above.

### Formation of Eutectic Complex

The skilled person can select the appropriate eutectic members at the appropriate molar ratio to provide the desired eutectic composition. The skilled person appreciates that the molar ratio of the first compound (e.g. Lewis base) of the pair to the second compound (e.g. Lewis acid) of the pair will vary based upon the compounds selected. As the skilled person will also appreciate, the melting point suppression of a eutectic solvent includes the eutectic point, which is the molar ratio of the first compound to the second compound that yields the maximum melting point suppression (i.e. deep eutectic solvent). The molar ratio of the first compound to the second compound can, however, be varied to nonetheless produce a suppression in the melting point of a eutectic solvent relative to the individual melting points of the first and second compounds that is not the minimum melting point (i.e. not the point of maximum suppression). Practice of one or more embodiments of the present invention therefore includes the formation of a eutectic solvent at molar ratios outside of the eutectic point.

In one or more embodiments, the compounds of the eutectic pair, as well as the molar ratio of the first compound to the second compound of the pair, are selected to yield a mixture having a melting point below 130° C., in other embodiments below 110° C., in other embodiments below 100° C., in other embodiments below 80° C., in other embodiments below 60° C., in other embodiments below 40° C., and in other embodiments below 30° C. In these or other embodiments, the compounds of the eutectic pair, as well as the molar ratio of the compounds, are selected to yield a mixture having a melting point above 0° C., in other embodiments above 10° C., in other embodiments above 20° C., in other embodiments above 30° C., and in other embodiments above 40° C.

In one or more embodiments, the compounds of the eutectic pair, as well as the molar ratio of the first compound to the second compound of the pair, are selected to yield a eutectic solvent having an ability or capacity to dissolve desired metal compounds, which may be referred to as solubility or solubility power. As the skilled person will appreciate, this solubility can be quantified based upon the weight of metal compound dissolved in a given weight of eutectic solvent over a specified time at a specified temperature and pressure when saturated solutions are prepared. In one or more embodiments, the eutectic solvents of the present invention are selected to achieve a solubility for zinc oxide, over 24 hours at 50° C. under atmospheric pressure, of greater than 100 ppm, in other embodiments greater than 500 ppm, in other embodiments greater than 1000 ppm, in other embodiments greater than 1200 ppm, in other embodiments greater than 1400 ppm, and in other embodiments greater than 1600 ppm, where ppm is measured on a weight solute to weight solvent basis.

In one or more embodiments, a eutectic solvent is formed by combining the first compound with the second compound at an appropriate molar ratio to provide a solvent composition (i.e. liquid composition at the desired temperature). The mixture may be mechanically agitated by using various techniques including, but not limited to, solid state mixing or blending techniques. Generally speaking, the mixture is mixed or otherwise agitated until a liquid that is visibly homogeneous is formed. Also, the mixture may be formed at elevated temperatures. For example, the eutectic solvent may be formed by heating the mixture to a temperature of greater than 50° C., in other embodiments greater than 70° C., and in other embodiments greater than 90° C. Mixing may continue during the heating of the mixture. Once a desired mixture is formed, the eutectic solvent can be cooled to room temperature. In one or more embodiments, the cooling of the eutectic solvent may take place at a controlled rate such as at a rate of less than 1° C./min.

In one or more embodiments, useful eutectic compositions can be obtained commercially. For example, deep eutectic solvents are commercially available under the tradenames Ionic Liquids from Scionix. Useful eutectic compositions are also generally known as described in U.S. Publ. Nos. 2004/0097755 A1 and 2011/0207633 A1, which are incorporated herein by reference.

### EPDM

As suggested above, the vulcanizable compositions of this invention include an EPDM polymer, which may also be referred to as an olefinic terpolymer. In one or more embodiments, the olefinic terpolymer includes merunits that derive from ethylene, α-olefin, and optionally diene monomer. Useful α-olefins include propylene. In one or more embodiments, the diene monomer may include dicyclopentadiene, alkyldicyclopentadiene, 1,4-pentadiene, 1,4-hexadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-n-propylidene-2-norbornene, 5-(2-methyl-2-butenyl)-2-norbornene, and mixtures thereof. Olefinic terpolymers and methods for their manufacture are known as disclosed at U.S. Pat. No. 3,280,082 as well as U.S. Publication No. 2006/0280892, both of which are incorporated herein by reference. Furthermore, olefinic terpolymers and methods for their manufacture as related to non-black membranes are known as disclosed in co-pending U.S. applilcation Ser. Nos. 12/389,145, 12/982,198, and 13/287,417, which are also incorporated herein by reference. For purposes of this specification, elastomeric terpolymers may simply be referred to as EPDM.

In one or more embodiments, the elastomeric terpolymer may include at least 62 weight percent, and in other embodiments at least 64 weight percent merunits deriving from ethylene; in these or other embodiments, the elastomeric terpolymer may include at most 70 weight percent, and in other embodiments at most 69 weight percent, mer units deriving from ethylene. In one or more embodiments, the elastomeric terpolymer may include at least 2 weight percent, in other embodiments at least 2.4 weight percent, merunits deriving from diene monomer; in these or other embodiments, the elastomeric terpolymer may include at most 4 weight percent, and in other embodiments at most 3.2 weight percent, mer units deriving from diene monomer. In one or more embodiments, the balance of the merunits derive from propylene or other α-olefins.

As is known in the art, it is within the scope of the present invention to blend low Mooney EPDM terpolymers with high Mooney EPDM terpolymers to reduce the overall viscosity of the membrane compound. In other words, EPDM terpolymers with different molecular weights may be utilized to accommodate processing.

In one or more embodiments, multiple EPDM polymers of different type (e.g. size and crystallinity) may be included. In one or more embodiments, at least one EPDM polymer may be characterized by a Mooney viscosity (ML₁₊₄@125° C.) of less than 60, in other embodiments less than 55, and in other embodiments less than 50, in other embodiments less than 45, in other embodiments less than 40, in other embodiments less than 35, and in other embodiments less than 30. In one or more embodiments, the one or more layers of the membranes of the present invention may derive directly from the vulcanization (e.g., sulfur crosslinking) of a vulcanizable composition including a rubber component that includes from about 2 to about 40 wt %, in other embodiments from about 3 to about 20 wt %, and in other embodiments from about 5 to about 12 wt % of an EPDM characterized by a Mooney viscosity of less than 60, in other embodiments less than 55, in other embodiments less than 50, in other embodiments less than 45, in other embodiments less than 40, in other embodiments less than 35, with the balance of the rubber component including EPDM characterized by a Mooney viscosity of 60 or higher.

### Cure System

As suggested above, the vulcanizable compositions of this invention include a cure system. The cure system includes a curative, which may also be referred to as rubber curing agent or vulcanizing agent. Curing agents are described in Kirk-Othmer, ENCYCLOPEDIA OF CHEMICAL TECHNOLOGY, Vol. 20, pgs. 365-468, (3^{rd} Ed. 1982), particularly Vulcanization Agents and Auxiliary Materials, pgs. 390-402, and A. Y. Coran, Vulcanization, ENCYCLOPEDIA OF POLYMER SCIENCE AND ENGINEERING, (2^{nd} Ed. 1989), which are incorporated herein by reference. Useful cure systems include sulfur or a sulfur-based curatives. In one or more embodiments, the curative is sulfur. Examples of suitable sulfur vulcanizing agents include “rubbermaker's” soluble sulfur; sulfur donating vulcanizing agents, such as an amine disulfide, polymeric polysulfide or sulfur olefin adducts; and insoluble polymeric sulfur. Vulcanizing agents may be used alone or in combination. The skilled person will be able to readily select the amount of vulcanizing agents to achieve the level of desired cure.

In one or more embodiments, the sulfur cure systems may be employed in combination with vulcanizing accelerators. Useful accelerators include thioureas such as ethylene thiourea, N,N-dibutylthiourea, N,N-diethylthiourea and the like; thiuram monosulfides and disulfides such as tetramethylthiuram monosulfide (TMTMS), tetrabutylthiuram disulfide (TBTDS), tetramethylthiuram disulfide (TMTDS), tetraethylthiuram monosulfide (TETMS), dipentamethylenethiuram hexasulfide (DPTH) and the like; benzothiazole sulfenamides such as N-oxydiethylene-2-benzothiazole sulfenamide, N-cyclohexyl-2-benzothiazole sulfenamide, N,N-diisopropyl-2-benzothiazolesulfenamide, N-tert-butyl-2-benzothiazole sulfenamide (TBBS) (available as Delac® NS from Chemtura, Middlebury, Conn.) and the like; other thiazole accelerators such as 2-mercaptobenzothiazole (MBT), benzothiazyl disulfide (MBTS), N,N-diphenylguanidine, N,N-di-(2-methylphenyl)-guanidine, 2-(morpholinodithio)benzothiazole disulfide, zinc 2-mercaptobenzothiazole and the like; dithiocarbamates such as tellurium diethyldithiocarbamate, copper dimethyldithiocarbamate, bismuth dimethyldithiocarbamate, cadmium diethyldithiocarbamate, lead dimethyldithiocarbamate, sodium butyldithiocarbamate, zinc diethyldithiocarbamate, zinc dimethyldithiocarbamate, zinc dibutyldithiocarbamate (ZDBDC) and mixtures thereof. Sulfur donor-type accelerators (e.g. di-morpholino disulfide and alkyl phenol disulfide) may be used in place of elemental sulfur or in conjunction with elemental sulfur if desired. The amount of accelerator can also be readily determined by those skilled in the art.

### Metal Compound/Activator and Organic Acid

As suggested above, the vulcanizable composition of one or more embodiments of the present invention includes a metal compound. In one or more embodiments, the metal compound is an activator (i.e. assists in the vulcanization or cure of the rubber). In one or more embodiments, the metal activator is a metal oxide. In particular embodiments, the metal activator is a zinc species that is formed in situ through a reaction or interaction between zinc oxide and organic acid (e.g. stearic acid). In other embodiments, the metal compound is a magnesium compound such as magnesium hydroxide. In other embodiments, the metal compound is an iron compound such as an iron oxide. In other embodiments, the metal compound is a cobalt compound such as a cobalt carboxylate.

In one or more embodiments, the zinc oxide is an unfunctionalized zinc oxide characterized by a BET surface area of less than 10 m²/g, in other embodiments, less than 9 m²/g, and in other embodiments, less than 8 m²/g. In other embodiments, nano zinc oxide is employed, which includes those zinc oxide particles that are characterized by a BET surface area of greater than 10 m²/g.

In one or more embodiments, the organic acid is a carboxylic acid. In particular embodiments, the carboxylic acid is a fatty acid including saturated and unsaturated fatty acids. In particular embodiments, saturated fatty acids, such as stearic acid, are employed. Other useful acids include, but are not limited to, palmitic acid, arachidic acid, oleic acid, linoleic acid, and arachidonic acid.

### Filler

As mentioned above, vulcanizable compositions of one or more embodiments of the present invention include filler. These fillers may include those conventionally employed in the art, as well as combinations of two or more of these fillers.

In one or more embodiments, the filler may include carbon black. Examples of useful carbon blacks include those generally characterized by average industry-wide target values established in ASTM D-1765. Exemplary carbon blacks include GPF (General-Purpose Furnace), FEF (Fast Extrusion Furnace), and SRF (Semi-Reinforcing Furnace). One particular example of a carbon black is N650 GPF Black, which is a petroleum-derived reinforcing carbon black having an average particle size of about 60 nm and a specific gravity of about 1.8 g/cc. Another example is N330, which is a high abrasion furnace black having an average particle size about 30 nm, a maximum ash content of about 0.75%, and a specific gravity of about 1.8 g/cc.

In lieu of or in addition to the use of carbon black, the vulcanizable compositions may include inorganic fillers. Useful inorganic fillers include, but are not limited to, silica, clay, mica, and talc, such as those disclosed in U.S. Publication No. 2006/0280892, which is incorporated herein by reference.

In one or more embodiments, the filler may include silica. Examples of suitable silica fillers include precipitated amorphous silica, wet silica (hydrated silicic acid), dry silica (anhydrous silicic acid), fumed silica, calcium silicate, aluminum silicate, magnesium silicate, and the like.

In one or more embodiments, silicas may be characterized by their surface areas, which give a measure of their reinforcing character. The Brunauer, Emmet and Teller (“BET”) method (described in J. Am. Chem. Soc., vol. 60, p. 309 et seq.) is a recognized method for determining the surface area. The BET surface area of silica is generally less than 450 m²/g. Useful ranges of surface area include from about 32 to about 400 m²/g, about 100 to about 250 m²/g, and about 150 to about 220 m²/g.

Where one or more silicas is employed, the pH's of the silicas are generally from about 5 to about 7 or slightly over 7, or in other embodiments from about 5.5 to about 6.8.

In one or more embodiments, where silica is employed as a filler (alone or in combination with other fillers), a coupling agent and/or a shielding agent may be utilized during mixing. Useful coupling agents and shielding agents are disclosed in U.S. Pat. Nos 3,842,111, 3,873,489, 3,978,103, 3,997,581, 4,002,594, 5,580,919, 5,583,245, 5,663,396, 5,674,932, 5,684,171, 5,684,172 5,696,197, 6,608,145, 6,667,362, 6,579,949, 6,590,017, 6,525,118, 6,342,552, and 6,683,135, which are incorporated herein by reference. Examples of sulfur-containing silica coupling agents include bis(trialkoxysilylorgano)polysulfides or mercapto-organoalkoxysilanes. Types of bis(trialkoxysilylorgano)polysulfides include bis (trialkoxysilylorgano) disulfide and bis(trialkoxysilylorgano)tetrasulfides.

### Expandable Graphite

In one or more embodiments, the vulcanizable compositions of the present invention may include expandable graphite, which may also be referred to as expandable flake graphite, intumescent flake graphite, or expandable flake. In one or more embodiments, expandable graphite includes intercalated graphite in which an intercallant material is included between the graphite layers of graphite crystal or particle. Examples of intercallant materials include halogens, alkali metals, sulfates, nitrates, various organic acids, aluminum chlorides, ferric chlorides, other metal halides, arsenic sulfides, and thallium sulfides. In certain embodiments of the present invention, expandable graphite includes non-halogenated intercallant materials. In certain embodiments, expandable graphite includes sulfate intercallants, also referred to as graphite bisulfate. As is known in the art, bisulfate intercalation is achieved by treating highly crystalline natural flake graphite with a mixture of sulfuric acid and other oxidizing agents which act to catalyze the sulfate intercalation.

Commercially available examples of expandable graphite include HPMS Expandable Graphite (HP Materials Solutions, Inc., Woodland Hills, Calif.) and Expandable Graphite Grades 1721 (Asbury Carbons, Asbury, N.J.). Other commercial grades contemplated as useful in the present invention include 1722, 3393, 3577, 3626, and 1722HT (Asbury Carbons, Asbury, N.J.).

In one or more embodiments, expandable graphite may be characterized as having a mean or average size in the range from about 30 μm to about 1.5 mm, in other embodiments from about 50 μm to about 1.0 mm, and in other embodiments from about 180 to about 850 μm. In certain embodiments, expandable graphite may be characterized as having a mean or average size of at least 30 μm, in other embodiments at least 44 μm, in other embodiments at least 180 μm, and in other embodiments at least 300 μm. In one or more embodiments, expandable graphite may be characterized as having a mean or average size of at most 1.5 mm, in other embodiments at most 1.0 mm, in other embodiments at most 850 μm, in other embodiments at most 600 μm, in yet other embodiments at most 500 μm, and in still other embodiments at most 400 μm. Useful expandable graphite includes Graphite Grade #1721 (Asbury Carbons), which has a nominal size of greater than 300 μm.

In one or more embodiments, expandable graphite may be characterized as having a nominal particle size of 20×50 (US sieve). US sieve 20 has an opening equivalent to 0.841 mm and US sieve 50 has an opening equivalent to 0.297 mm. Therefore, a nominal particle size of 20×50 indicates the graphite particles are at least 0.297 mm and at most 0.841 mm.

In one or more embodiments, expandable graphite may be characterized as having a carbon content in the range from about 70% to about 99%. In certain embodiments, expandable graphite may be characterized as having a carbon content of at least 80%, in other embodiments at least 85%, in other embodiments at least 90%, in yet other embodiments at least 95%, in other embodiments at least 98%, and in still other embodiments at least 99% carbon.

In one or more embodiments, expandable graphite may be characterized as having a sulfur content in the range from about 0% to about 8%, in other embodiments from about 2.6% to about 5.0%, and in other embodiments from about 3.0% to about 3.5%. In certain embodiments, expandable graphite may be characterized as having a sulfur content of at least 0%, in other embodiments at least 2.6%, in other embodiments at least 2.9%, in other embodiments at least 3.2%, and in other embodiments 3.5%. In certain embodiments, expandable graphite may be characterized as having a sulfur content of at most 8%, in other embodiments at most 5%, in other embodiments at most 3.5%.

In one or more embodiments, expandable graphite may be characterized as having an expansion ratio (cc/g) in the range from about 10:1 to about 500:1, in other embodiments at least 20:1 to about 450:1, in other embodiments at least 30:1 to about 400:1, in other embodiments from about 50:1 to about 350:1. In certain embodiments, expandable graphite may be characterized as having an expansion ratio (cc/g) of at least 10:1, in other embodiments at least 20:1, in other embodiments at least 30:1, in other embodiments at least 40:1, in other embodiments at least 50:1, in other embodiments at least 60:1, in other embodiments at least 90:1, in other embodiments at least 160:1, in other embodiments at least 210:1, in other embodiments at least 220:1, in other embodiments at least 230:1, in other embodiments at least 270:1, in other embodiments at least 290:1, and in yet other embodiments at least 300:1. In certain embodiments, expandable graphite may be characterized as having an expansion ratio (cc/g) of at most 350:1, and in yet other embodiments at most 300:1.

In one or more embodiments, expandable graphite, as it exists with the sheet of the present invention, is at least partially expanded. In one or more embodiments, the expandable graphite is not expanded, however, to a deleterious degree, which includes that amount or more of expansion that will deleteriously affect the ability to form the sheet product and the ability of the graphite to serve as flame retardant at desirable levels, which include those levels that allow proper formation of the sheet. In one or more embodiments, the expandable graphite is expanded to at most 100%, in other embodiments at most 50%, in other embodiments at most 40%, in other embodiments at most 30%, in other embodiments at most 20%, and in other embodiments at most 10% beyond its original unexpanded size.

In one or more embodiments, expandable graphite may be characterized as having a pH in the range from about 1 to about 10; in other embodiments from about 1 to about 6; and in yet other embodiments from about 5 to about 10. In certain embodiments, expandable graphite may be characterized as having a pH in the range from about 4 to about 7. In one or more embodiments, expandable graphite may be characterized as having a pH of at least 1, in other embodiments at least 4, and in other embodiments at least 5. In certain embodiments, expandable graphite may be characterized as having a pH of at most 10, in other embodiments at most 7, in other embodiments at most 6.5, in other embodiments at most 6, and in other embodiments at most 5.

In one or more embodiments, expandable graphite may be characterized by an onset temperature ranging from about 100° C. to about 280° C.; in other embodiments from about 160° C. to about 225° C.; and in other embodiments from about 180° C. to about 200° C. In one or more embodiments, expandable graphite may be characterized by an onset temperature of at least 100° C., in other embodiments at least 130° C., in other embodiments at least 160° C., in other embodiments at least 170° C., in other embodiments at least 180° C., in other embodiments at least 190° C., and in other embodiments at least 200° C. In one or more embodiments, expandable graphite may be characterized by an onset temperature of at most 250° C., in other embodiments at most 225° C., and in other embodiments at most 200 ° C. Onset temperature may also be interchangeably referred to as expansion temperature; it may also be referred to as the temperature at which expansion of the graphite starts.

### Flame Retardants

In one or more embodiments, the vulcanizable compositions of the present invention may include a flame retardant. Flame retardants may include any compound that increases the burn resistivity, particularly flame spread such as tested by UL 94 and/or UL 790, in the polymeric compositions of the present invention. Generally, useful flame retardants include those that operate by forming a char-layer across the surface of a specimen when exposed to a flame. Other flame retardants include those that operate by releasing water upon thermal decomposition of the flame retardant compound. Useful flame retardants may also be categorized as halogenated flame retardants or non-halogenated flame retardants.

Exemplary non-halogenated flame retardants include magnesium hydroxide, aluminum trihydrate, zinc borate, ammonium polyphosphate, melamine polyphosphate, and antimony oxide (Sb₂O₃). Magnesium hydroxide (Mg(OH)₂) is commercially available under the tradename Vertex™ 60, ammonium polyphosphate is commercially available under the tradename Exolite™ AP 760 (Clarian), which is sold together as a polyol masterbatch, melamine polyphosphate is available under the tradename Budit™ 3141 (Budenheim), and antimony oxide (Sb₂O₃) is commercially available under the tradename Fireshield™. Those flame retardants from the foregoing list that are believed to operate by forming a char layer include ammonium polyphosphate and melamine polyphosphate.

### Extenders

As mentioned above, the vulcanizable compositions of the present invention may include extenders. Useful extenders include paraffinic, naphthenic oils, and mixtures thereof. These oils may be halogenated as disclosed in U.S. Pat. No. 6,632,509, which is incorporated herein by reference. In one or more embodiments, useful oils are generally characterized by low surface content, low aromaticity, low volatility and a flash point of more than about 550° F. Useful extenders are commercially available. One particular extender is a paraffinic oil available under the tradename SUNPAR™ 2280 (Sun Oil Company). Another useful paraffinic process oil is Hyprene P150BS, available from Ergon Oil Inc. of Jackson, Miss.

### Other Constituents

In addition to the foregoing constituents, the vulcanizable compositions may also optionally include mica, coal filler, ground rubber, titanium dioxide, calcium carbonate, silica, homogenizing agents, phenolic resins, and mixtures thereof as disclosed in U.S. Publication No. 2006/0280892, which is incorporated herein by reference. Certain embodiments may be substantially devoid of any of these constituents.

### Amounts

### Rubber

In one or more embodiments, the vulcanizable composition includes greater than 20, in other embodiments greater than 30, and in other embodiments greater than 40 percent by weight of the rubber (e.g. EPDM), based upon the entire weight of the vulcanizable composition. In these or other embodiments, the vulcanizable composition includes less than 90, in other embodiments less than 70, and in other embodiments less than 60 percent by weight of the rubber (e.g. EPDM) based on the entire weight of the vulcanizable composition. In one or more embodiments, the vulcanizable composition includes from about 20 to about 90, in other embodiments from about 30 to about 70, and in other embodiments from about 40 to about 60 percent by weight of the rubber (e.g. EPDM) based upon the entire weight of the vulcanizable composition. In one or more embodiments, the vulcanizable composition of one or more embodiments includes from about 20 to about 50, in other embodiments from about 24 to about 36, and in other embodiments from about 28 to about 32% by weight rubber (e.g. EPDM) based on the entire weight of the vulcanizable composition.

### Eutectic Composition

In one or more embodiments, the vulcanizable composition includes greater than 0.005, in other embodiments greater than 0.01, and in other embodiments greater than 0.02 parts by weight (pbw) of the eutectic composition per 100 parts by weight rubber (phr). In these or other embodiments, the vulcanizable composition includes less than 3, in other embodiments less than 1, and in other embodiments less than 0.1 pbw of the eutectic composition phr. In one or more embodiments, the vulcanizable composition includes from about 0.005 to about 3, in other embodiments from about 0.01 to about 1, and in other embodiments from about 0.02 to about 0.1 pbw of the eutectic composition phr.

In one or more embodiments, the amount of eutectic solvent can be described with reference to the loading of metal activator (such as zinc oxide). In one or more embodiments, the vulcanizable composition includes greater than 2, in other embodiments greater than 3, and in other embodiments greater than 5 wt % eutectic solvent based upon the total weight of the eutectic solvent and the metal activator (e.g. zinc oxide) present within the vulcanizable composition. In these or other embodiments, the vulcanizable composition includes less than 15, in other embodiments less than 12, and in other embodiments less than 10 wt % eutectic solvent based upon the total weight of the eutectic solvent and the metal activator (e.g. zinc oxide) present within the vulcanizable composition. In one or more embodiments, the vulcanizable composition includes from about 2 to about 15, in other embodiments from about 3 to about 12, and in other embodiments from about 5 to about 10 wt % eutectic solvent based upon the total weight of the eutectic solvent and the metal activator (e.g. zinc oxide) present within the vulcanizable composition.

### Metal Compound

In one or more embodiments, the vulcanizable composition includes greater than 0.05, in other embodiments greater than 0.1, and in other embodiments greater than 0.15 parts by weight (pbw) of metal activator (e.g. zinc oxide) per 100 parts by weight rubber (phr). In these or other embodiments, the vulcanizable composition includes less than 2, in other embodiments less than 1, and in other embodiments less than 0.75 pbw of metal activator (e.g. zinc oxide) phr. In one or more embodiments, the vulcanizable composition includes from about 0.05 to about 2, in other embodiments from about 0.1 to about 1, and in other embodiments from about 0.15 to about 0.75 pbw of metal activator (e.g. zinc oxide) phr.

### Organic Acid

In one or more embodiments, the vulcanizable composition includes greater than 0.5, in other embodiments greater than 0.7, and in other embodiments greater than 1.0 parts by weight (pbw) of organic acid (e.g. stearic acid) per 100 parts by weight rubber (phr). In these or other embodiments, the vulcanizable composition includes less than 5, in other embodiments less than 3, and in other embodiments less than 2 pbw of organic acid (e.g. stearic acid) phr. In one or more embodiments, the vulcanizable composition includes from about 0.5 to about 5, in other embodiments from about 0.7 to about 3, and in other embodiments from about 1.0 to about 2 pbw of organic acid (e.g. stearic acid) phr.

### Filler

In one or more embodiments, the vulcanizable composition includes at least one layer that includes from about 50 to about 120, in other embodiments from about 60 to about 115, in other embodiments from about 70 to about 110, and in other embodiments from about 80 to about 105 parts by weight (pbw) inorganic filler (e.g. clay) per 100 parts by weight rubber (phr) (e.g. EPDM). In certain embodiments, the vulcanizable composition includes at least one layer that includes less than 120 pbw, in other embodiments less than 115 pbw, in other embodiments less than 110 pbw, in other embodiments less than 105 pbw, and in other embodiments less than 100 pbw, inorganic filler phr. In these or other embodiments, the vulcanizable composition includes at least one layer that includes greater than 50 pbw, in other embodiments greater than 60 pbw, in other embodiments greater than 70 pbw, in other embodiments greater than 80 pbw, and in other embodiments greater than 90 pbw inorganic filler phr.

In one or more embodiments, the vulcanizable composition includes from about 70 to about 100 pbw, in other embodiments from about 75 to about 95 pbw, and in other embodiments from about 77 to about 85 pbw carbon black phr. Certain embodiments may be substantially devoid of carbon black.

In one or more embodiments, the vulcanizable composition includes from about 78 to about 103 pbw, in other embodiments from about 85 to about 100 pbw, and in other embodiments from about 87 to about 98 pbw clay phr. Certain embodiments may be substantially devoid of clay.

In one or more embodiments, the vulcanizable composition includes from about 10 to about 100 pbw silica phr. In other embodiments, the membrane includes less than 70 pbw silica phr, and in other embodiments less than 55 pbw silica phr. In certain embodiments, the vulcanizable composition is devoid of silica.

In one or more embodiments, the vulcanizable composition includes from about 12 to about 25 pbw mica phr. In other embodiments, the membrane includes less than 12 pbw phr mica, and in other embodiments less than 6 pbw mica phr. In certain embodiments, the vulcanizable composition is devoid of mica.

In one or more embodiments, the vulcanizable composition includes from 5 to about 60 pbw, in other embodiments from about 10 to about 40 pbw, and in other embodiments from about 20 to about 25 pbw talc phr. Certain embodiments may be substantially devoid of talc.

In one or more embodiments, the vulcanizable compositions can be characterized by the ratio of the amount of a first filler to the amount of a second filler. In one or more embodiments, the ratio of the amount of first filler to second filler is about 1:1, in other embodiments about 10:1, in other embodiments about 14:1, and in other embodiments about 20:1. In one or more embodiments, the ratio of the amount of first filler to second filler is about 1:5, in other embodiments about 1:10, in other embodiments about 1:14, and in other embodiments about 1:20.

### Flame Retardant

In one or more embodiments, the vulcanizable composition includes at least one layer that includes from about 1 to about 50, in other embodiments from about 2 to about 40, in other embodiments from about 3 to about 35, in other embodiments from about 5 to about 30, and in other embodiments from about 7 to about 25 parts by weight (pbw) flame retardant per 100 parts by weight rubber (phr) (e.g. EPDM). In certain embodiments, the vulcanizable composition includes at least one layer that includes less than 50 pbw, in other embodiments less than 40 pbw, in other embodiments less than 35 pbw, in other embodiments less than 30 pbw, in other embodiments less than 25 pbw, in other embodiments less than 20 pbw, and in other embodiments less than 15 pbw flame retardant phr. In these or other embodiments, the vulcanizable composition includes at least one layer that includes greater than 2 pbw, in other embodiments greater than 3 pbw, in other embodiments greater than 5 pbw, in other embodiments greater than 7 pbw, in other embodiments greater than 10 pbw, in other embodiments greater than 15 pbw, and in other embodiments greater than 20 pbw flame retardant phr.

In one or more embodiments, the vulcanizable composition is devoid or substantially devoid of halogen-containing flame retardants. In one or more embodiments, the vulcanizable composition includes less than 5 pbw, in other embodiments less than 1 pbw, and in other embodiments less than 0.1 pbw halogen-containing flame retardant phr. In particular embodiments, the vulcanizable composition is substantially devoid of DBDPO.

In one or more embodiments, the vulcanizable composition includes at least one layer that includes from about 1 to about 50, in other embodiments from about 2 to about 40, in other embodiments from about 3 to about 35, in other embodiments from about 5 to about 30, and in other embodiments from about 7 to about 25 parts by weight (pbw) expandable graphite per 100 parts by weight rubber (phr) (e.g. EPDM). In certain embodiments, the vulcanizable composition includes at least one layer that includes less than 50 pbw, in other embodiments less than 40 pbw, in other embodiments less than 35 pbw, in other embodiments less than 30 pbw, in other embodiments less than 25 pbw, in other embodiments less than 20 pbw, and in other embodiments less than 15 pbw expandable graphite phr. In these or other embodiments, the vulcanizable composition includes at least one layer that includes greater than 2 pbw, in other embodiments greater than 3 pbw, in other embodiments greater than 5 pbw, in other embodiments greater than 7 pbw, in other embodiments greater than 10 pbw, in other embodiments greater than 15 pbw, and in other embodiments greater than 20 pbw expandable graphite phr.

### Other

In one or more embodiments, the vulcanizable composition includes from about 55 to about 95 pbw, in other embodiments from about 60 to about 85 pbw, and in other embodiments from about 65 to about 80 pbw extender phr. Certain embodiments may be substantially devoid of extender.

In one or more embodiments, the vulcanizable composition includes from about 2 to about 10 pbw homogenizing agent phr. In other embodiments, the vulcanizable composition includes less than 5 pbw homogenizing agent phr, and in other embodiments less than 3 pbw homogenizing agent phr. In certain embodiments, the vulcanizable composition is devoid of homogenizing agent.

In one or more embodiments, the vulcanizable composition includes from about 2 to about 10 pbw phenolic resin phr. In other embodiments, the vulcanizable composition includes less than 4 pbw phenolic resin phr, and in other embodiments, less than 2.5 pbw phenolic resin phr. In certain embodiments, the vulcanizable composition is devoid of phenolic resin.

### Methods of Manufacture

In one or more embodiments, the EPDM roofing membranes of the present invention can be prepared by employing conventional techniques including those described in U.S. Pat. Nos. 6,632,509, 6,515,059, 5,854,327, 5,700,538, 5,582,890, 5,512,118, 5,486,550, and 5,407,989, which are incorporated herein reference. In one or more embodiments, continuous processes for the production of EPDM membrane sheet may also be employed including those described in U.S. Pat Nos. 6,093,354 and 10,112,334; and International Publication No. WO 2017165871, which are incorporated herein by reference.

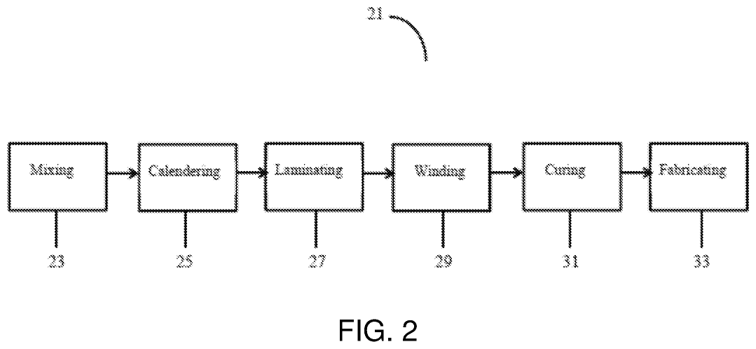

A process for preparing EPDM membrane sheet according to the present invention can be described with reference to FIG. 2. Process 21 may begin by preparing a vulcanizable composition within a mixing step 23. This vulcanizable composition can then be prepared into a sheet material within, for example, a calendaring step 25. Following formation of the sheet, two or more layers may be laminated to form a laminated product, optionally by inclusion of a reinforcing scrim between the layers, within a laminating step 27. The laminated product may then be dusted as generally known to the skilled person such that the laminated product may then be wound within a winding step 29 to produce an uncured, wound membrane ready for vulcanization. Vulcanization may take place within a curing step 31. Once cured, the membrane may undergo final fabrication within fabricating step 33.

Preparation of the vulcanizable mixture within mixing step 23 may take place within conventional rubber compounding equipment such as Brabender, Banbury, Sigma-blade mixer, two-roll mill, extruders, or other mixers suitable for forming viscous, relatively uniform admixtures. In one or more embodiments, the ingredients can be added together in a single shot. In other embodiments, some of the ingredients, such as the eutectic composition, fillers, oils, etc., can be loaded first followed by the polymer. In other embodiments, the polymer is added first followed by the other ingredients. Mixing cycles generally range from about 2 to 6 minutes. In certain embodiments an incremental procedure can be used whereby the base polymer and part of the other ingredients are added first with little or no process oil, and the remaining ingredients and process oil are added in additional increments. In other embodiments, part of the EPDM can be added on top of the fillers, plasticizers, etc. This procedure can be further modified by withholding part of the process oil, and then adding it later. In one or more embodiments, two-stage mixing can be employed.

In one or more embodiments, the eutectic composition is prepared prior to introducing the eutectic composition to the vulcanizable rubber. In other words, the first constituent of the eutectic mixture is pre-combined with the second constituent of the eutectic mixture prior to introducing the eutectic mixture to the vulcanizable composition.

In one or more embodiments, the combined constituents of the eutectic mixture are mixed until a homogeneous liquid composition is observed.

In one or more embodiments, the eutectic mixture is pre-combined with one or more ingredients of the rubber formulation prior to introducing the eutectic mixture to the vulcanizable composition. In other words, in one or more embodiments, a constituent of the vulcanizable composition (e.g. a metal compound such as zinc oxide) is combined with the eutectic mixture to form a pre-combination or masterbatch prior to introducing the pre-combination to the mixer in which the rubber is mixed. For example, zinc oxide may be dissolved in the eutectic solvent prior to introduction to the rubber within the mixer. In other embodiments, the eutectic composition is the minor component of the pre-combination, and therefore the constituent that is pre-mixed with the eutectic composition acts as a carrier for the eutectic composition. For example, the eutectic composition can be combined with a larger volume of zinc oxide, and the zinc oxide will act as a carrier for delivery the combination of zinc oxide and eutectic composition as a solid to the rubber within the mixer. In yet other embodiments, one of the members of the eutectic pair acts as a solid carrier for the eutectic composition, and therefore the combination of the first and second ingredients of the eutectic composition form a pre-combination that can be added as a solid to the rubber within the mixer. The skilled person will appreciate that mixtures of this nature can be formed by combining an excess of the first or second eutectic members as excess, relative to the other eutectic member, to maintain a solid composition at the desired temperature.

In certain embodiments, such as when utilizing a type-B Banbury internal mixer, the dry or powdery materials such as the carbon black and non-black mineral fillers (i.e., untreated clay, treated clays, talc, mica, and the like) can be added first, followed by the liquid process oil and finally the polymer (this type of mixing can be referred to as an upside-down mixing technique). In these or other embodiments, all of the non-rubber ingredients are added first to the mixer. The rubber (i.e. EPDM rubber) is added on top of these ingredients, and then mixing is initiated.

In one or more embodiments, mixing takes place under sufficient heat and mixing energy to achieve an internal composition temperature of greater than 120° C., in other embodiments greater than 130° C., in other embodiments greater than 140° C., and in other embodiments greater than 150° C. In these or other embodiments, mixing takes place under sufficient heat and mixing energy to achieve an internal composition temperature of less than 180° C., in other embodiments less than 175° C., in other embodiments less than 170° C., in other embodiments less than 165° C., in other embodiments less than 160° C., and in other embodiments less than 155° C.

Following this initial mixing, the masterbatch can be cooled to temperatures below 160° C., in other embodiments below 140° C., and in other embodiments below 130° C., which may take place by dropping the masterbatch from the mixer. Once cooled, the composition can be again charged to a mixing apparatus and additional components may or may not be added, as described elsewhere herein. This subsequent mixing may take place at temperatures below 160° C., in other embodiments below 155° C., in other embodiments below 150° C., and in other embodiments below 145° C. In one or more embodiments, subsequent mixing may take place at temperatures of from about 120° C. to about 155° C., or in other embodiments from about 130° C. to about 150° C.

After this mixing, preparation of the vulcanizable composition can then be completed by the addition and subsequent mixing with the cure system. Prior to adding the cure system to the vulcanizable composition, the vulcanizable composition can be cooled to temperatures below 130° C., in other embodiments below 115° C., in other embodiments below 100° C., and in other embodiments below 80° C. As above, cooling may take place by dropping the mixture from the mixer.

The mixing in the presence of the cure system may occur at temperatures below 150° C., in other embodiments below 130° C., in other embodiments below 110° C., and in other embodiments below 100° C. In certain embodiments, mixing in the presence of the cure system may occur at a temperature of from about 70° C. to about 110° C., or in other embodiments from about 95° C. to about 105° C. The resultant product from this mixing step may be referred to as the final vulcanizable composition.

In one or more embodiments, and as discussed above, the eutectic solvent is introduced to the vulcanizable rubber as an initial ingredient in the formation of a rubber masterbatch. As a result, the eutectic solvent undergoes high shear, high temperature mixing with the rubber. In one or more embodiments, the eutectic solvent undergoes mixing with the rubber at minimum temperatures in excess of 110° C., in other embodiments in excess of 130° C., and in other embodiments in excess of 150° C. In one or more embodiments, high shear, high temperature mixing takes place ata temperature from about 110° C. to about 170° C. In one or more embodiments, the eutectic solvent undergoes mixing with the rubber at a temperature of from about 140° C. to about 180° C., or in other embodiments from about 150° C. to about 170° C.

In other embodiments, and as discussed above, the eutectic solvent is introduced to the vulcanizable rubber, either sequentially or simultaneously, with the sulfur-based curative. As a result, the eutectic solvent may undergo mixing with the vulcanizable rubber at a maximum temperature below 110° C., in other embodiments below 105° C., and in other embodiments below 100° C. In one or more embodiments, mixing with the curative takes place at a temperature from about 70° C. to about 110° C.

As with the eutectic solvent, the zinc oxide and the stearic acid can be added as initial ingredients to the rubber masterbatch, and therefore these ingredients will undergo high temperature, high shear mixing. Alternatively, the zinc oxide and the stearic acid can be added along with the sulfur-based curative and thereby only undergo low-temperature mixing.

In one or more embodiments, the zinc oxide is introduced to the vulcanizable rubber separately and individually from the eutectic solvent. In other embodiments, the zinc oxide and the eutectic solvent are pre-combined to form a zinc oxide masterbatch, which may include a solution in which the zinc oxide is dissolved or otherwise dispersed in the eutectic solvent. The zinc oxide masterbatch can then be introduced to the vulcanizable rubber.

In certain embodiments, blends of different Mooney viscosity EPDM rubber may be employed. For example, the blend may include from about 2 to about 40 wt %, in other embodiments from about 3 to about 20 wt %, and in other embodiments from about 5 to about 12 wt % of an EPDM characterized by a Mooney viscosity of less than 60, in other embodiments less than 55, in other embodiments less than 50, in other embodiments less than 45, in other embodiments less than 40, in other embodiments less than 35, with the balance of the rubber component including EPDM characterized by a Mooney viscosity of 60 or higher.

In one or more embodiments, the mixing procedure employed includes the preparation of first and second vulcanizable compositions that are distinct based upon the presence and absence of a eutectic composition. For example, a first vulcanizable composition can be prepared that includes a eutectic composition, and a second vulcanizable composition can be prepared that excludes a eutectic composition. Prior to calendering, the first and second vulcanizable compositions can be combined and mixed, which may take place in an apparatus such as a mill or extruder. This technique advantageously allows the composition containing a eutectic composition to be processed differently.

In those embodiments where one layer of a multi-layered membrane is devoid or substantially devoid of a eutectic composition, the vulcanizable composition employed to fabricate this layer can be prepared as described herein absent the eutectic composition, or procedures otherwise known in the art can be employed. The skilled person will appreciate that the respective vulcanizable compositions can then be respectively prepared into sheets (calendered sheets) and then laminated together as described elsewhere herein.

In one or more embodiments, the sulfur cure package (sulfur/accelerator) can be added near the end of the mixing cycle and at lower temperatures to prevent premature crosslinking of the EPDM polymer chains.

In one or more embodiments, the mixing step may include the use of multiple apparatus or sub steps. For example, cooling of the composition may take place on one or more mills. Mills may also be used to warm the composition prior to further mixing within a mixer or extruder. In certain embodiments, the composition may be passed through and extruder and, for example, optionally screened, to remove impurities that could have a deleterious impact on calendaring. Further mixing and dispersion of the non-rubber ingredients may also be accomplished in an extruder.

Once mixed, the vulcanizable composition can then be formed into a sheet by using standard techniques such as calendering or extrusion. The sheet may also be cut to a desired dimension. In one or more embodiments, the vulcanizable mixture can be sheeted to thicknesses ranging from 5 to 200 mils, or in other embodiments from 35 to 90 mils, by using conventional sheeting methods, for example, milling, calendering or extrusion. In one or more embodiments, the admixture is sheeted to at least 40 mils (0.040-inches), which is the minimum thickness specified in manufacturing standards established by the Roofing Council of the Rubber Manufacturers Association (RMA) for non-reinforced EPDM rubber sheets for use in roofing applications. In other embodiments, the vulcanizable mixture is sheeted to a thickness of about 45 mils, which is the thickness for a large percentage of “single-ply” roofing membranes used commercially. In one or more embodiments, the calendered sheeting itself should show good, uniform release from the upper and lower calendar rolls and have a smooth surface appearance (substantially free of bubbles, voids, fish eyes, tear drops, etc.). It should also have uniform release from the suction (vacuum) caps at the splicing table and uniform surface dusting at the dust box.

As suggested above, the membranes of the present invention, which may be referred to as single-ply membranes or panels, may nonetheless include multiple sheets of EPDM that are co-cured into a single panel or sheet. The panel can be optionally reinforced with scrim. In other embodiments, the membranes are devoid of scrim. The multi-layered membrane (also referred to as a panel) can be constructed or fabricated within a laminating step whereby two or more calendered sheets of green (i.e. uncured) EPDM rubber, optionally together with a reinforcing scrim, are mated by using laminating techniques to produce a green membrane panel.

Once a green membrane panel is prepared, the green panel may be prepared for curing by adding release agents to at least one planar surface of the panel. The release agents, which may include talc, mica, cellulose, and the like, serves to prevent sticking and ultimate adhesion of the sheet after winding, especially during curing, which typically takes place while the sheet is in a wound state. Techniques for preparing the green membrane panel for subsequent curing are generally known in the art as described, for example, in U.S. Publ. No. 2010/0205896, which is incorporated herein by reference. In other embodiments, a curing sheet or liner may be employed whereby a protective liner in rolled with the sheet to prevent the sheet from curing to itself. In any event, the green membrane panel can be wound onto a curing roll within, for example, a winding step.

Once wound, the green membrane panel can undergo curing with a curing step. In one or more embodiments, vulcanization may take place in an autoclave. Where an in-line process is used, curing may take place by hot air or by rotary cure. In one or more embodiments, vulcanization of the EPDM sheet may take place at temperatures of greater than 150° C., in other embodiments greater than 155° C., in other embodiments greater than 160° C., in other embodiments greater than 165° C., in other embodiments greater than 175° C., and in other embodiments greater than 190° C. In these or other embodiments, vulcanization may take place at temperatures of from about 130° C. to about 230° C., in other embodiments from about 140° C. to about215° C., or in other embodiments from about 145° C. to about 200° C. In one or more embodiments, vulcanization may take place at increased pressures. For example, vulcanization may take place at pressures of greater than 1.5, in other embodiments greater than 2.0, in other embodiments greater than 2.5, in other embodiments greater than 3.0, and in other embodiments greater than 3.5 atmospheres.

In other embodiments, processes that cure the membrane using continuous processes can be employed. Useful techniques are disclosed in U.S. Pat. No. 6,093,354 and U.S. Publ. Nos. 2015/0076743 and 2019/0047199, which are incorporated herein by reference.

The sheeting can be visually inspected and cut to the desired length and width dimensions after curing with a final fabrication step. Generally speaking, the membrane may be unrolled after curing, inspected and cut to a desired length and width, optionally enhanced with a tape and/primer layer, and then ultimately rolled for storage and shipping. For various fabrication techniques, reference can be made to U.S. Publ. No. 2007/0137777, which is incorporated herein by reference.

The roof sheeting membranes can be evaluated for physical properties using test methods developed for mechanical rubber goods. Typical properties include, among others, tensile strength, modulus, ultimate elongation, tear resistance, ozone resistance, water absorption, burn resistivity, and cured compound hardness.

### Membrane Construction

In one or more embodiments, membranes of the present invention may be black or non-black. The membranes include a cured network deriving from a vulcanizable rubber composition. The various other ingredients, such as the eutectic composition, may be dispersed throughout the cured network. The membranes may also be described as a crosslinked network of EPDM forming a matrix in which the other constituents are dispersed. The membrane may also be referred to as a sheet. The membrane may further comprise fabric reinforcement. The EPDM sheet may be devoid of fabric reinforcement or it may include a fabric reinforcement positioned between two or more plies or layers of rubber. In one or more embodiments, the membranes may be devoid of halogen-containing flame retardants.

In one or more embodiments, the membranes, although commonly referred to as single-ply roofing membranes, may include two or more layers that are the same or are distinct. The two layers may or may not have similar compositions. The layers may be formed by calendering. For example, first and second sheets may be formed from first and second respective rubber compositions, and then the respective sheets can be mated and further calendered or laminated to one another, optionally with a reinforcing fabric therebetween, and then ultimately cured. The skilled person will recognize, however, that these layers may be integral to the extent that the calendering and/or curing process creates an interface, at some level, and the layers are generally inseparable. Nonetheless, reference can be made to the individual layers, especially where the layers derive from distinct compositions. Reference may also be made a multi-layered sheet.

In one or more embodiments, the membrane is a calendered sheet wherein a first composition including a eutectic composition is calendered to form a first layer of the membrane, and a second composition including a eutectic composition is calendered to form a second layer of the membrane. In one or more embodiments, the membrane is a calendered sheet wherein a first composition including a eutectic composition is calendered to form a first layer of the membrane, and a second composition that is devoid or substantially devoid of eutectic composition is calendered to form a second layer of the membrane.

In particular embodiments, reference may be made to the weathering layer and the bottom layer. As the skilled person will appreciate, the weathering layer is that layer exposed to the environment when the membrane is installed, and the bottom layer is the opposite surface, which is adjacent to the substrate on which the membrane is installed.

In one or more embodiments, the membranes of the present invention are two-layered membranes, wherein the first layer of the membrane is black in color and the second layer is non-black in color (e.g. white or generally white). As those skilled in the art appreciate, the black layer can derive from a black composition that would generally include carbon black as a filler. The white layer can derive from a white composition that would generally include non-black fillers such as silica, titanium dioxide, and/or clay. White EPDM membranes or membranes having a white EPDM layer are known in the art as disclosed in U.S. Ser. No 12/389,145, which is incorporated herein by reference.

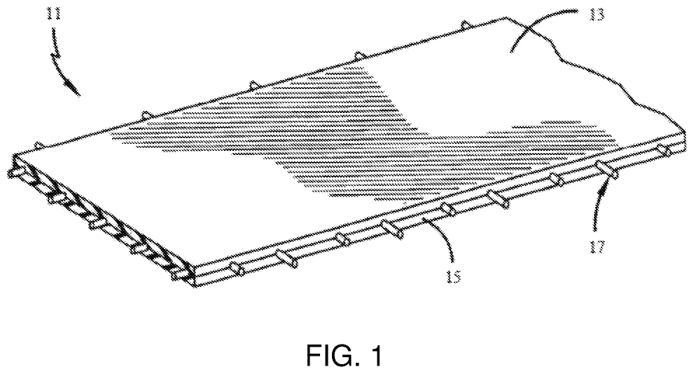

An exemplary EPDM sheet according to embodiments of the invention is shown in FIG. 1. Sheet 11, which may also be referred to as panel 11, is a multi-layered sheet including first layer 13 and second layer 15. An optional reinforcing fabric 17 is disposed (e.g., sandwiched) between first layer 13 and second layer 15. Layers 13 and 15 may be calendared and co-cured, thereby providing an integral interface between the layers. In one or more embodiments, the eutectic composition is used to form the first layer 13 and second layer 15. First layer 13 may be black or non-black in color. In one or more embodiments, first layer 13 may be devoid or substantially devoid of expandable graphite. In these or other embodiments, second layer 15 is the bottom layer and may be black in color.

Generally, the thickness of the sheet ranges from about 20 to about 100 mils, in other embodiments from about 35 to about 95 mils, and in other embodiments from about 45 to about 90 mils. In one or more embodiments, the EPDM sheet meets the performance standards of ASTM D4637.

### Membrane Performance Standards

In one or more embodiments, the membranes of the invention demonstrate burn resistivity that meets or exceeds standards of flame spread such as tested by UL 94 and/or UL 790. Further, in one or more embodiments, the membranes of the invention meet standards of resistance to wind uplift as tested in accordance with test method UL 1897. In these or other embodiments, the membranes of the present invention meet the performance standards of ASTM D 4637.

According to aspects of the present invention, the membranes, which may also be referred to as vulcanizates, are characterized by advantageous cure characteristics while including relatively low levels of metal activator such as zinc species.

In one or more embodiments, the vulcanizates are characterized by including less than 2 pbw, in other embodiments, less than 1 pbw, and in other embodiments, less than 0.7 pbw zinc per 100 parts by weight rubber (phr) (e.g., EPDM).

### Membrane Installation

The membranes of this invention may be unrolled over a roof substructure in a conventional fashion, wherein the seams of adjacent sheets are overlapped and mated by using, for example, an adhesive. The width of the seam can vary depending on the requirements specified by the architect, building contractor, or roofing contractor, and they thus do not constitute a limitation of the present invention. Seams can be joined with conventional adhesives such as, for instance, a butyl-based lap splice adhesive, which is commercially available from Firestone Building Products Company as SA-1065. Application can be facilitated by spray, brush, swab or other means known in the art. Also, field seams can be formed by using tape and companion primer such as QuickSeam™ tape and Quick Prime Plus primer, both of which are commercially available from Firestone Building Products Company of Carmel, Ind.

Also, as is known in the art, these membranes can be secured to the roof substructure by using, for example, mechanical fasteners, adhesives (which are often employed to prepare a fully-adhered roofing system), or ballasting. In particular embodiments, the membrane is formed into a composite membrane that includes an adhesive layer that can be used to adhesively secure the membrane to the roof by using, for example, peel-and-stick techniques as disclosed in U.S. Publ. No. 2017/0114543, which is incorporated herein by reference.

Accordingly, the membranes of this invention may be used to prepare roof systems. As those skilled in the art appreciate, these systems typically include a roof deck, an optional layer of insulation (e.g. polyisocyanurate board stock), an optional layer of cover board (e.g. OSB board, DensDeck or high-density polyisocyanurate board), and then the membranes of this invention forming the outer most roof covering. In this regard, U.S. Pat. No. 7,972,688 is incorporated herein by reference.

It is also contemplated to use the concepts of the present invention in EPDM flashings such as those disclosed in U.S. Pat. No. 5,804,661, which is also incorporated herein by reference. As the skilled person understands, flashings include membranes that can be used in certain locations of a roofing system where a typical membrane panel is not practical. For example, flashings can be used at or near transitions on a roof such as where the membrane system meets a parapet wall. In one or more embodiments, these flashings include EPDM, but are uncured as delivered to the job site. In the uncured state, the flashing is more flexible or pliable, and therefore more efficiently installed. Exposure to the environment, such as UV radiation and/heat, cause the uncured EPDM flashing to cure in place on the roof. Advantageously, these flashings can be black in color, such as disclosed in U.S. Pat. No. 5,804,661, or they can be white in color. In either event, white and black flashing may include metal oxides, such as zinc oxide, and therefore may benefit from practice of the present invention.

Various modifications and alterations that do not depart from the scope and spirit of this invention will become apparent to those skilled in the art. This invention is not to be duly limited to the illustrative embodiments set forth herein.

1. A method of preparing an EPDM roofing membrane panel comprising:
(i) preparing a vulcanizable composition including a eutectic composition by mixing an EPDM rubber, a sulfur-based curative, zinc oxide, and a eutectic composition;
(ii) forming a sheet from the vulcanizable composition;
(iii) preparing a green membrane panel using the sheet; and
(iv) curing the green membrane panel to form the EPDM roofing membrane panel.

2-9. (canceled)

10. The method of claim 1, where said vulcanizable composition includes less than 2 pbw zinc oxide per 100 pbw rubber.

11. (canceled)

12. The method of claim 1, where the eutectic composition is formed by combining choline chloride and urea.

13. The method of claim 1, where the vulcanizable composition includes from about 0.005 to about 3 pbw of the eutectic composition per 100 pbw rubber.

14. (canceled)

15. The method of claim 1, where eutectic composition is defined by the formula Cat⁺X⁻zY, where Cat⁺ is a cation, X⁻ is a counter anion (c.g. Lcwis Base), and z refers to the number of Y molecules that interact with the counter anion (c.g. Lcwis Base.

16. The method of claim 15, where Cat⁺ is an ammonium, phosphonium, or sulfonium cation and X⁻ is a halide ion.

17. (canceled)

18. The method of claim 1, where the eutectic composition is formed by combining an ammonium compound with a metal halide, a metal halide hydrate, or a hydrogen bond donor.

19. The method of claim 18, where the ammonium compound ammonium compounds, may be defined by the formula II:
(R₁)(R₂)(R₃)(R₄)—N⁺-Φ⁻
where each R₁, R₂, R₃, and R₄ is individually hydrogen or a monovalent organic group, or, in the alternative, two of R₁, R₂, R₃, and R₄ join to form a divalent organic group, and Φ⁻ is a counter anion.

20. The method of claim 18, where the ammonium compound is selected from the group consisting of N-ethyl-2-hydroxy-N,N-dimethylethanaminium chloride, 2-hydroxy-N,N,N-trimethylethanaminium chloride (which is also known as choline chloride), and N-benzyl-2-hydroxy-N,N-dimethlethanaminium chloride.

21. The method of claim 18, where the ammonium compound is selected from the group consisting of and 2-chloro-N,N,N-trimethylethanaminium (which is also referred to as chlorcholine chloride), and 2-(chlorocarbonyloxy)-N,N,N-trimethylethanaminium chloride.

22. The method of claim 18, where the hydrogen bond donor is selected from the group consisting of amines, amides, carboxylic acids, and alcohols.

23. The method of claim 18, where the hydrogen bond donor is selected from the group consisting of aliphatic amines, ethylenediamine, diethylenetriamine, aminoethylpiperazine, triethylenetetramine, tris(2-aminoethyl)amine, N,N′-bis-(2aminoethyle)piperazine, piperazinoethylethylenediamine, and tetraethylenepentaamine, propyleneamine, aniline, substituted aniline, and combinations thereof.

24. The method of claim 18, where the hydrogen bond donor is selected from the group consisting of urea, 1-methyl urea, 1,1-dimethyl urea, 1,3-dimethylurea, thiourea, urea, benzamide, acetamide, and combinations thereof.

25. The method of claim 18, where the hydrogen bond donor is selected from the group consisting of phenylpropionic acid, phenylacetic acid, benzoic acid, oxalic acid, malonic acid, adipic acid, succinic acid, citric acid, tricarballylic acid, and combinations thereof.

26. The method of claim 18, where the hydrogen bond donor is selected from the group consisting of aliphatic alcohols, phenol, substituted phenol, ethylene glycol, propylene glycol, resorcinol, substituted resorcinol, glycerol, benzene triol, and mixtures thereof.

27. The method of claim 18, where the metal halide is selected from the group consisting of aluminum chloride, aluminum bromide, aluminum iodide, zinc chloride, zinc bromide, zinc iodide, tin chloride, tin bromide, tin iodide, iron chloride, iron bromide, iron iodide, and combinations thereof.

28. The method of claim 1, where eutectic composition is provided with a carrier.

29. The method of claim 28, where the carrier is a solid.

30. The method of claim 28, where the carrier is zinc oxide.

31. The method of claim 28, where the carrier is a eutectic member.

32. The method of claim 1, where the eutectic composition is a eutectic solvent at standard conditions.

33. The method claim 1, where the eutectic composition is a deep eutectic solvent.

34. The method of claim 1, where the zinc oxide is dissolved in the eutectic solvent.

35. A method of preparing an EPDM roofing membrane rubber vulcanizate comprising:
(i) providing a vulcanizable composition of matter including vulcanizable EPDM rubber, a sulfur-based curative, zinc oxide, and a eutectic composition; and
(ii) heating the vulcanizable composition to thereby effect vulcanization.

36. An EPDM rubber roofing membrane comprising at least one layer of a cured EPDM rubber made by the method of claim 1.
